(19) United States
(12) Patent Application Publication
(10) Pub. No.: US 2017/0240349 A1
(43) Pub. Date: Aug. 24, 2017

(54) PACK FOR PREPARING FOODS OR BEVERAGES

(71) Applicant: NESTEC S.A., Vevey (CH)

(72) Inventors: Silvio Butscher, Chezard-st-Martin (CH); Valerie Vivier, Divonne les Bains (FR); Claire Dubesset, Denens (CH)

(21) Appl. No.: 15/503,865

(22) PCT Filed: Jul. 23, 2015
(86) PCT No.: PCT/EP2015/066829

§ 371 Date: Feb. 14, 2017

(30) Foreign Application Priority Data
Aug. 14, 2014 (EP) 14181046.5

(51) Int. Cl. B65D 85/804; A47J 31/36; A47J 31/40; B65D 75/58; B65B 29/02

(52) U.S. Cl. CPC B65D 85/8043; B65D 75/5883; B65B 29/02; A47J 31/407; A47J 31/369

(57) ABSTRACT

A pack (100) having an inner volume in which a food or beverage ingredient is stored and in which a food or beverage product is produced when a fluid is introduced inside, said inner volume being defined by sheets of material joined to one another at their edges and said inner volume presenting a generally plane shape defining a plane (P) essentially vertically oriented during beverage production, said pack (100) comprising at least one fluid inlet (110) for supplying a fluid in the inner volume and at least one dispensing outlet (120) for delivering the food or beverage product from said inner volume, said fluid inlet (110) and said dispensing outlet (120) being positioned at the bottom of the pack (100) and being at least partially positioned between two joined edges of the sheets of material, the fluid inlet (110) being oriented essentially perpendicularly to the plane (P) defined by the inner volume, the dispensing outlet (120) being configured as an essentially parallel tube arranged essentially vertically from the inner volume, configured so as to enable a free flow of the food or beverage product form the pack (100), the dispensing outlet (120) comprising a primary outlet section (300) and a secondary outlet section (400), the secondary outlet section (400) being arranged vertically higher than the primary outlet section (300) and having a bigger diameter than that of the primary outlet section, such configuration allowing the sequential dispensing of the food or beverage product at least in two phases, a first phase where dispensing is done through the primary outlet section (300) and a second phase where dispensing is done through the secondary outlet section (400).

### FIELD OF THE INVENTION

The present invention relates to a pack for the preparation of foods or beverages; in particular it refers to a disposable pack comprising a food or beverage ingredient, this pack being used for the preparation of foods or beverages in a reduced amount of time and having an optimal quality, yet having a simple configuration.

### BACKGROUND OF THE INVENTION

Preparing beverages by introducing a capsule containing a food or beverage ingredient, such as ground coffee or instant coffee, in a beverage dispensing machine and injecting water into the capsule is known in the state of the art: the beverage or food ingredient is typically extracted or dissolved into water to form the beverage or the desired final product, which flows out of the capsule through a suitable outlet.

As such, different capsules have been developed in the past, these capsules being at least differentiated by the nature of the capsule body used for storing the food or the beverage ingredient. Whereas most of the capsules are made of a rigid body or semi-rigid body, typically made though injection moulding or thermoforming, flexible types of packs can be made out of foil materials. Flexible packs have generally the advantage to semi-rigid and rigid capsules that less amount of material is used to pack the product which leads to overall less production cost, to lower life cycle impact shown in several life-cycle assessments and to advantages on the part of the user, who will need less available space for storing these packs, as they are more compact.

For example, WO 99/05044 describes a flexible beverage-producing sachet comprising a beverage ingredient in a volume formed by bonding two laminates at their edges, having a base seam into which a conduit of rigid plastics is bonded. An inlet nozzle is provided at the top of the resulting sachet for introducing water that is mixed with the beverage or food ingredient inside the inner volume of the sachet, the beverage produced being then evacuated through a beverage outlet arranged at the bottom of the pack, where closing means are provided, such that the closing means are adapted to open under pressure when pressurized water is introduced into the sachet, allowing the beverage to evacuate through the beverage outlet. However, this configuration presents important drawbacks for the consumer: the opening of the closing means is obtained by increase of pressure inside the sachet. Yet this pressure increase is not recommended for the preparation of some beverages because it creates bubbles at the surface of the beverage, for example this would not be desired for the preparation of tea. Besides, there exists the risk for the user that the packages may not rupture at the desired pressure, and that they would finally open up in an uncontrollable explosion. For this reason the apparatus where the sachet is processed needs to comprise means for totally enclosing the sachet in the machine during beverage preparation in order to avoid damages for the consumer.

It is also known from the state of the art, for example as per WO 2011/024103, a flexible pouch or sachet for preparing a beverage such as coffee, comprising a space where a concentrated dose of the product is stored. The pouch comprises also a rigid part on one of the sides of the pouch, provided with an inlet through which water is inserted into the pouch, a tube element conveying the water towards the opposite part of the pouch, so that the mixing of the water and the ingredient is made, and an outlet through which the product is dispensed. During the preparation of the beverage the beverage outlet is positioned at the top of the pouch. Water is introduced through the inlet and through the tube element until it fills the pouch and overflows through the beverage outlet positioned at the top of the pouch too. Such a pouch is conceived for preparing a beverage by extraction of roast and ground coffee but not by dissolution of instant coffee or other soluble materials. For this reason the pouch comprises a filter at the outlet to prevent insoluble particles from being dispensed with the beverage. An inconvenient of such a pouch is that at the end of the preparation of the beverage and the introduction of water, beverage remains in the pouch which is an issue for the user who cannot properly remove the pouch from the beverage production machine. Besides, in this pouch, neither the water inlet nor the beverage outlet are closed by a membrane, which is not recommended in terms of hygiene and shelf life as it could present problems to the consumer.

Known documents in the state of the art, such as WO 99/05044, GB 2 374 856 and WO 2012/175985 describe similar flexible packs made of two sheets of flexible air-and-liquid-impermeable material bonded on their edges to define an inner volume where the beverage ingredient will be stored. However, these flexible sachets present drawbacks, as already explained. Another drawback of these sachets is that the inlet spout introduces water in the pack always according to the same vertical top-down orientation in the sachet. Then all the beverages are produced according to the same process inside the sachet. Yet depending on the nature of the beverage ingredient and the desired beverage the beverage ingredient should be processed differently depending e.g. if foam is desired or not. In WO2012175985 a solution has been proposed which consists in proposing a beverage machine with different brewing heads (clamp) either for high pressure or low pressure beverage preparation, which is complicated and requires long time.

Another drawback of these sachets is that they do not enable the delivery of foamy beverages, in particular milky beverages, directly from the sachet. Foamy beverages must be frothed in the drinking cup with a water jet as described in GB2374586. This implementation requires a longer time to prepare a foamy beverage (first for preparing the beverage from the sachet, secondly for frothing the beverage with the water jet) and does not give the feeling of a high quality beverage to the consumer.

Also, different types of beverages will be desired to be delivered from a flexible pack: however, when using existing known flexible solutions for delivering for example long beverages, the consumer will need to wait for a long time to have the beverage prepared, which is certainly inconvenient. Besides, other types of thick products, for example beverages comprising pulp or the like, will not be able to be delivered using existing solutions. Even more, foamed food or beverage products are not able to be made either, as already explained. The present invention is therefore intended to solve these limitations.

The object of the present invention is to propose a pack for the preparation of a food or beverage that improves the above-mentioned problems in terms of manufacturing, beverage preparation simplicity and cleanliness, leading to an optimal overall beverage quality, allowing different types of food or beverages to be prepared, in a reduced amount of time, and yet maintaining a simple execution of the pack and its components.

The present invention comes to provide a solution to the above-described needs, as it will be further explained. The invention also aims at other objects and particularly at the solution of other problems as will appear in the rest of the present description.

### SUMMARY OF THE INVENTION

According to a first aspect, the invention relates to a pack 100 having an inner volume in which a food or beverage ingredient is stored and in which a food or beverage product is produced when a fluid is introduced inside, said inner volume being defined by sheets of material joined to one another at their edges and said inner volume presenting a generally plane shape defining a plane P essentially vertically oriented during beverage production. Said pack 100 comprises at least one fluid inlet 110 for supplying a fluid in the inner volume and at least one dispensing outlet 120 for delivering the food or beverage product from said inner volume, said fluid inlet 110 and said dispensing outlet 120 being positioned at the bottom of the pack 100 and being at least partially positioned between two joined edges of the sheets of material.

According to the invention, the fluid inlet 110 is oriented essentially perpendicularly to the plane P defined by the inner volume, the dispensing outlet 120 being configured as an essentially parallel tube arranged essentially vertically from the inner volume, configured so as to enable a free flow of the food or beverage product form the pack 100. Preferably, the dispensing outlet 120 comprises a primary outlet section 300 and a secondary outlet section 400, the secondary outlet section 400 being arranged vertically higher than the primary outlet section 300 and having a bigger diameter than that of the primary outlet section, such configuration allowing the sequential dispensing of the food or beverage product at least in two phases, a first phase where dispensing is done through the primary outlet section 300 and a second phase where dispensing is done through the secondary outlet section 400.

The dispensing outlet 120 preferably comprises a primary weakened area 122 arranged in the primary outlet section 300 and a secondary weakened area 400 that allow the opening of the primary outlet section 300 and of the secondary outlet section 400, respectively.

Typically, the secondary weakened area 132 is configured as a hinge, allowing the opening of the secondary outlet section 400 by pivoting over the primary outlet section 300.

According to the invention, the secondary weakened area 132 comprises a primary hinge element 132a and a secondary hinge element 132b, such that the secondary outlet section 400 can pivot over the primary outlet section 300 by rotating over any of these hinge elements.

The closing of the primary outlet section 300 and the primary outlet section 300 or the secondary outlet section 400 are typically attached to the pack 100 by means of a primary bond 128 and a secondary bond 138, respectively. According to the invention, the secondary weakened area 132 is configured such that it allows the detaching of the primary outlet section 300 from the secondary outlet section 400 in an essentially horizontal way. According to another embodiment of the invention, the secondary weakened area 132 is configured such that it allows the detaching of the primary outlet section 300 from the secondary outlet section 400 in a slanted way, under a detachment angle α.

Typically, the diameter of the dispensing outlet 120 is comprised in the range of about 1 mm to 6 mm.

The pack of the invention preferably comprises a single fitment assembly 10 comprising the fluid inlet 110 and the dispensing outlet 120, said fitment assembly 10 being positioned at the bottom of the pack 100 and being partially positioned between two joined edges of the sheets of material.

Preferably, the pack 100 also comprises an evacuating liquid outlet 600 which can be pierced for evacuating liquid from the inner volume of the pack 100.

The fluid inlet 110 is typically configured for providing an orientable high velocity jet 6 into the inner volume of the pack 100.

The pack 100 further comprises identification means 60 comprising the parameters information for the fluid supply into the fluid inlet 110 for each one of the sequential dispensing phases, also comprising the information on the duration in time of each phase, these parameters being at least one or a combination of: flow rate of fluid, temperature of fluid supply, total volume of fluid introduced in the fluid inlet 110, and/or duration of the jet supplied and/or pause in between jets.

According to a second aspect, the invention refers to a method for preparing a food or beverage product from a pack 100, the method comprising at least two sequential steps, such that each step is defined by its length in time and at least by one or a combination of the following parameters: temperature of the fluid (typically water) introduced by the piercing and injecting means in the inlet chamber 120; total volume of water introduced in the inlet chamber 120; and water flow provided through the piercing and injecting means also into the inlet chamber 120; duration of jet phase and pause in between jet phases.

Preferably, this method comprises two sequential phases, a first phase where the product is dispensed by the primary outlet section 300 and a second phase where the product is dispensed by the secondary outlet section 400.

More preferably, the preparation of the food or beverage product in the pack 100 in the method of the invention is done by a water jet 6 presenting a velocity of at least 20 m/s.

According to a third aspect, the invention refers to a machine 200 for preparing a food or beverage product from a pack 100 as described previously, the machine 200 comprising a receiving area 201 adapted to accommodate the pack 100 in an essentially vertical position during beverage production with the fluid inlet 110 and the dispensing outlet 120 being arranged at the bottom of the pack 100, the machine further comprising injecting means 30 designed for accommodating fluid into the fluid inlet 110.

Preferably, the machine 200 further comprises a data reader retrieving the parameters information for the fluid supply into the fluid inlet 110, comprising the information on the sequential dispensing phases and their duration in time and, for each phase the information of at least one or a combination of: temperature of the fluid (typically water) introduced by the piercing and injecting means in the inlet chamber 120; total volume of water introduced in the inlet chamber 120; water flow provided through the piercing and injecting means also into the inlet chamber 120; duration of jet phase and pause in between jet phases.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a general schematic view of a possible configuration of a disposable pack for preparing food or beverages according to the present invention.

FIG. 2 shows the possible different steps carried out for manufacturing a disposable pack for preparing food or beverages according to the present invention.

FIG. 3 shows schematically a possible configuration of the fluid inlet and injection hole in a fitment assembly of a disposable pack for preparing food or beverages according to the present invention in order to configure a water jet.

FIGS. 4a-b show a possible embodiment of a fitment assembly of a disposable pack for preparing food or beverages according to the present invention.

FIGS. 5a-b illustrate the movement of the liquid in the inner volume in the main plane P a disposable pack for preparing food or beverages according to the present invention.

FIG. 6 shows schematically the configuration of the dispensing outlet and the fitment assembly in a disposable pack for preparing food or beverages according to one embodiment of the present invention.

FIGS. 7a-b show details of the configuration of the dispensing outlet in a disposable pack for preparing food or beverages according to another embodiment of the present invention.

FIG. 8 shows the positioning of a disposable pack for preparing food or beverages on a slightly slanted plane in a food or beverage preparation machine according to an embodiment of the present invention.

FIG. 9 shows the introduction of a disposable pack for preparing food or beverages according to a globally horizontal sliding movement in a food or beverage preparation machine according to another embodiment of the present invention.

FIG. 10 shows the introduction of a disposable pack for preparing food or beverages according to a vertical sliding movement in a food or beverage preparation machine according to yet another embodiment of the present invention.

FIG. 11 shows the interaction of a disposable pack for preparing food or beverages according to the present invention with a food or beverage preparation machine.

FIG. 12 illustrates the possibility to create a range of disposable packs for preparing food or beverages with the same fitment assembly differing by the size of the inner volume, according to the present invention.

### DETAILED DESCRIPTION OF EXEMPLARY EMBODIMENTS

The present invention relates to a disposable pack 100 having an inner volume in which a food or a beverage ingredient is stored. When a fluid, typically water, is introduced in the inner volume of the pack 100 a food or a beverage is produced.

The disposable pack 100 according to the invention comprises at least one fluid inlet 110 for supplying a diluent in the inner volume of the pack 100. The pack 100 further comprises at least one dispensing outlet 120, through which the dispensing of the food or beverage from the inner volume of the pack, once prepared, takes place. Preferably, the fluid inlet 110 and the dispensing outlet 120 are positioned next to the bottom of the pack 100.

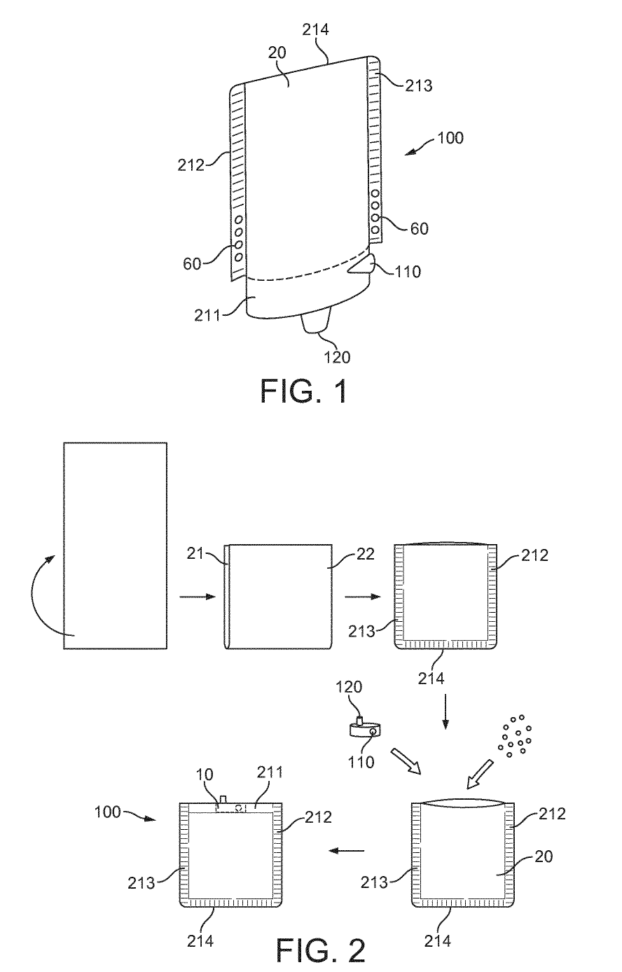

In the present application the terms “bottom”, “top”, “lateral”, “horizontal” and “vertical” are used to describe the relational positioning of the features of the invention. These terms should be understood to refer to the pack in its normal orientation when introduced in a food or beverage preparation machine for the production of a food or beverage as shown for example in FIG. 1. Preferably, the normal orientation of the pack will be essentially vertical.

According to the invention “next to the bottom” means that both the fluid inlet and the dispensing outlet are positioned on the bottom edge of the pack and/or on the bottom part of one of the lateral sides of the pack. The invention covers different variants where the fluid inlet and the dispensing outlet are on the same edge of the pack, either on the bottom edge or at the bottom part of a lateral side of the pack, also covering the variants where the fluid inlet is either on the bottom edge of the pack or on the bottom part of one of the lateral sides of the pack, the dispensing outlet being positioned at the bottom edge of the pack, and also variants where the fluid inlet is positioned frontally at the bottom part of the pack and the dispensing outlet is positioned at the bottom edge of the pack. According to the invention the bottom part of a lateral side of the pack generally corresponds to the part of said lateral side positioned below the middle part of the pack and preferably closer to the bottom part of the pack rather than the middle part of the pack.

In the present invention the term “fluid” covers any aqueous diluent that can be mixed with a soluble food or beverage ingredient to prepare a beverage, like water, carbonated water, milk, etc. or a food from a fluid ingredient being diluted. However, according to the invention, water is the preferred fluid which will be used.

Preferably the pack comprises two flexible water impermeable sheets joined to one another to define the inner volume of the pack. As a consequence the pack itself is substantially flexible and looks like a pouch or sachet. By flexible, it is meant that the sheets can be bent easily. The resulting pack can be bent also; it is soft and can be deformed contrary to rigid containers. The flexible sheet material can be plastic laminates, metallised foil or alufoil or fibre base material. According to the invention the two flexible water impermeable sheets can be formed of one single flexible water impermeable sheet folded in half and joined at its free edges. This embodiment constitutes a particularly easy way to manufacture the pack 100 since it requires the cutting of only one piece of sheet —most preferably according to a rectangular shape—and its folding to create the inner volume for the food or beverage ingredient. Typically, also for manufacturing convenience, the fitment assembly 10 is introduced in the bottom edge of the container during the sealing of its edges.

According to a specific embodiment the pack can comprise more than two sheets, in particular to increase the size of the inner volume. At least another sheet can be joined to the two first sheets that define the inner volume and the generally plane shape according to a plane. For example, said other sheet(s) can create a doypack shape or a stand up pouch for the inner volume of the pack. Generally said other sheet(s) is/are joined to the edges of the two first sheets of material which do not comprise the fluid inlet and the dispensing outlet.

It is preferred that the pack presents a generally plane shape. Preferably the plane shape is essentially vertically oriented during beverage production, with the fluid inlet and the dispensing outlet arranged next to the bottom of the pack.

In the present invention the fluid inlet and the dispensing outlet can be made in one single insert or in separate inserts positioned in the pack.

The pack 100 of the invention preferably comprises a fitment assembly 10 and a food or beverage container 20: the fitment assembly 10 typically comprises the fluid inlet 110 and the at least one dispensing outlet 120, and is preferably made as one piece in a rigid plastic material, preferably made by injection moulding. This plastic material can be selected in the list of: polypropylene, polyethylene, polyethylene terephthalate and polylactic acid. According to a less preferred embodiment the insert can be made out of a metal like aluminium or tin-plate. The container 20 is preferably flexible and comprises the inner volume where the food or beverage ingredient is stored.

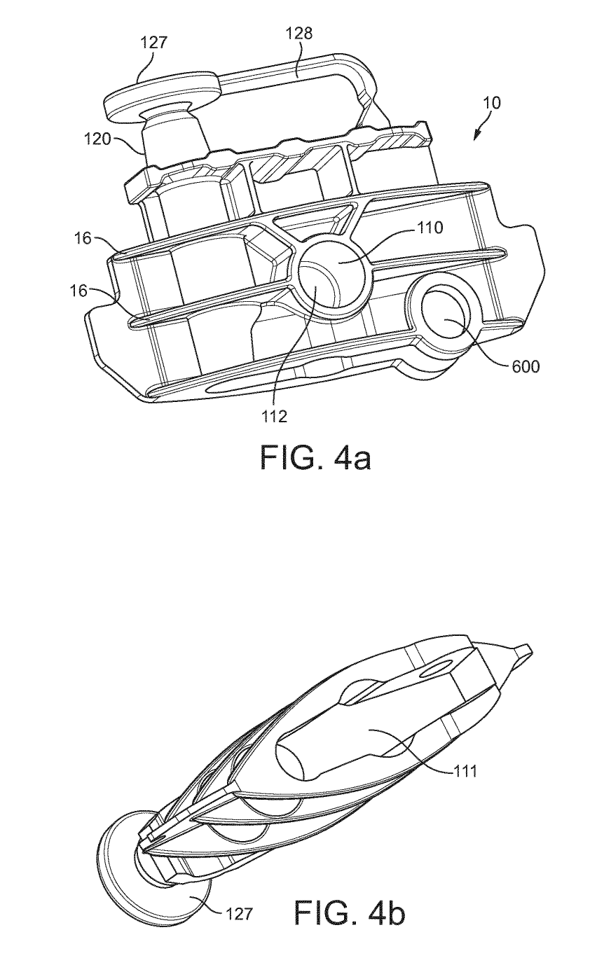

According to a preferred embodiment of the invention, the fluid inlet 110 is arranged frontally in the fitment assembly 10 and the at least one dispensing outlet 120 is configured as a straight tube or duct located parallel to the sheets configuring the container 20 so that it allows a free flow dispensing by gravity of the food or beverage product prepared. The fluid inlet 110 and the dispensing outlet 120 are therefore arranged, according to this preferred embodiment, perpendicular with respect to each other. This is illustrated in FIG. 4a or 4b.

According to the present invention the food or beverage ingredient of the pack can be comprised within the list of: soups, fruit juices, vegetable juices, bouillons, coffee, chocolate, tea, milk or creamer, smoothies, purees, coulis, creams or a combination thereof.

The food or beverage ingredient can be a soluble food or beverage ingredient. Preferably the food or beverage ingredient is a soluble food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered. The powders or liquid concentrates can be mixed with solid pieces for example for preparing soups with solid pieces.

The food or beverage ingredient can also be an infusable food or beverage ingredient like a roast and ground coffee or tea leaves. In that embodiment water extracts the infusable ingredient.

The fluid inlet 110 of the fitment assembly 10 is preferably configured as a yieldably piercable inlet 110 through which a diluent can be supplied into the inner volume of the food or beverage container 20 in order to properly mix the food or beverage ingredient contained in it with the diluent to prepare the subsequent food or beverage product.

The food or beverage container 20 preferably comprises two flexible water impermeable sheets 21, 22 joined one to another on their edges 211, 212, 213, 214 to define an inner volume where the food or beverage ingredient is stored. These two sheets 21, 22 can also be obtained by folding one single sheet in its middle part to form the top part 214 of the pack 100: in this case, only the edges 211, 212 and 213 have to be bonded together. Preferably, the bonding is done by heat sealing or thermo sealing.

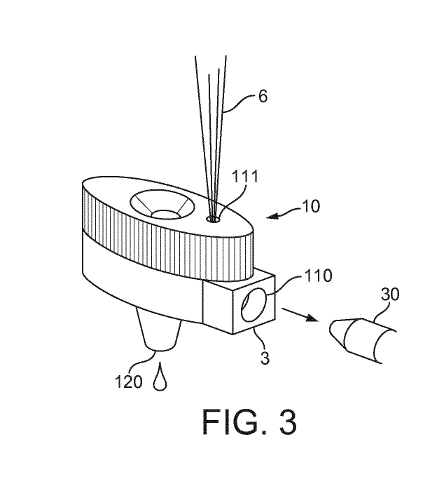

The fluid inlet 110 preferably is configured for supplying fluid, preferably water, in the form of a jet 6 into the inner volume of the container 20 through an injection hole 111, as represented in FIG. 3. It is to be noted that FIGS. 1 and 3 show the case where the supply of fluid from the fluid inlet 110 is done laterally though the preferred case is that where the fluid inlet 110 is arranged frontally in the fitment assembly 10. The fluid inlet 110 typically comprises an external lid which is the part of the inlet 110 being piercable: the lid is preferably made of one of the flexible sheets 21 or 22 when laid over the fitment assembly 10, for manufacturing convenience. Also, the fitment assembly 10 comprises at least one dispensing outlet 120 through which the food or beverage product is dispensed, though another possible and convenient embodiment would be that the fitment assembly 10 comprises two dispensing outlets, preferably arranged parallel with respect to each other. Once the food or beverage medium stored inside the volume of the container 20 is diluted with water coming from the injection hole 111, the food or beverage prepared is directed towards the dispensing outlet 120 from which it is dispensed. According to another embodiment of the invention, the fluid inlet 110 can be made as a through hole passing from one side to the other of the fitment assembly 10 i.e., passing from frontal to rear side and vice versa. On each side, frontal and rear, an external piercable lid will be provided such that, when piercing means pierce this lid frontally or on the rear side, fluid will be in any case injected and will be introduced in the pack through the injection hole 111. With such configuration, the pack is made reversible.

Typically, the dispensing outlet 120 together with the fluid inlet 110 are comprised in the fitment assembly 10 made of one single rigid piece or part, which will be preferably arranged at the bottom edge 211 of the pack 100 or at the bottom part of one of the lateral edges 212, 213 of the pack 100. It can also be that the fluid inlet 110 together with the injection hole 111 is made in one rigid insert, which can be positioned at the bottom of the pack 100, meaning that it is arranged at the bottom edge 211 of the pack 100 or at the bottom part of one of the lateral edges 212, 213 of the pack 100, and the dispensing outlet 120 will then be made in one separate rigid insert which will be arranged at the bottom edge 211 of the pack 100.

Preferably, the dispensing outlet 120 is configured as a straight hole either enclosed in the fitment assembly 10 or in a different rigid insert.

In the embodiment illustrated in FIG. 1 (though the preferred embodiment would be to have the fluid inlet 110 arranged frontally in the fitment assembly 10) the injection hole 111 is configured for introducing a water jet 6 essentially upwardly and vertically inside the inner volume of the container 20. Yet as illustrated in FIG. 3 the fluid inlet 110 could also be a straight hole essentially horizontally oriented and introducing the water jet 6 through the injection hole 111 essentially upwardly and vertically inside the inner volume of the container 20.

The fluid inlet and the dispensing outlet can be straight holes inside inserts or inside the fitment assembly because they are easy to manufacture. Yet other embodiments wherein the inserts define holes with at least one change of direction can be also implemented. Such a change of direction can be helpful to improve the interface of the inserts with the food or beverage preparation machine, in particular the interface between the machine water supply and the inlet insert. Such a change of direction can be helpful to control the water velocity in the inner volume of the container and/or the water jet orientation in the inner volume of the container also. The single insert configured as a single fitment assembly presents the advantage of being easily positioned in the edges of the pack when it is manufactured compared to two or more separate inserts.

The dispensing outlet 120 is preferably configured so that it delivers the food or beverage product as a free flow, meaning that the product can flow from the dispensing outlet 120 by simple gravity fall therefore presenting a sufficient section so as to enable a free flow of the beverage or food product from the pack. According to a preferred embodiment of the invention, the dispensing outlet 120 is a straight tube having a diameter comprised between 1 mm and 4 mm, more preferably comprised between 1.5 and 3 mm, even more preferably in the range of around 3 mm.

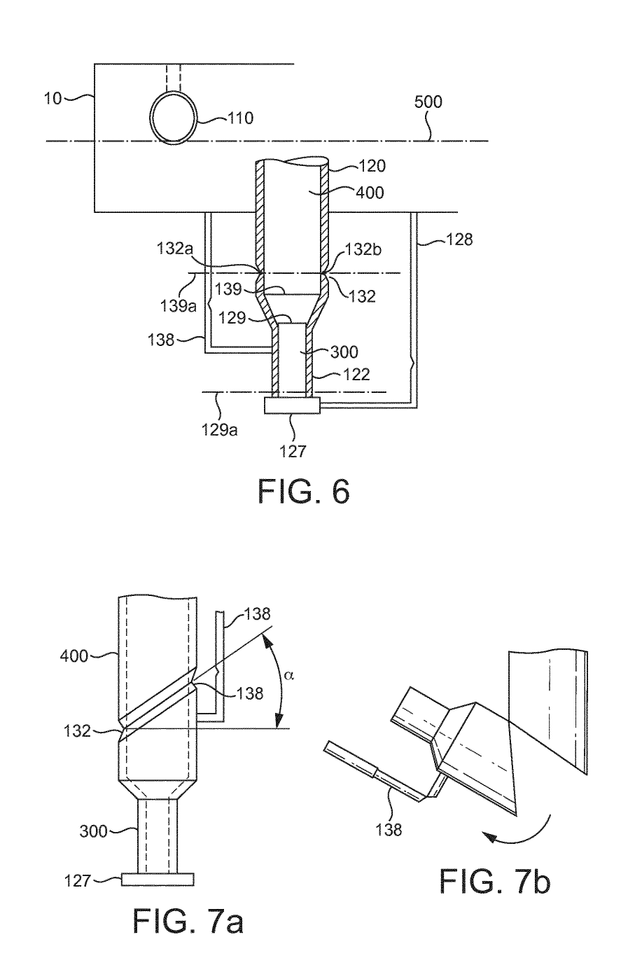

According to the invention, as illustrated in FIG. 6, the dispensing outlet 120 comprises a primary weakened area 122 preferably made as a narrowing of the tube, which will typically be cut and opened for beverage or food dispensing, either once the pack is arranged in a food and beverage preparation machine or once the process of preparing the food or beverage product starts. The lower side of the dispensing outlet 120 is closed by means of a primary closing plug 127 which is joined to the fitment assembly 10 by means of a primary bond 128, typically made of plastic. With such configuration, once the primary closing plug 127 is removed by cutting the primary weakened area 122, this primary closing plug 127 hangs from the primary bond 128 so that it does not disturb for the dispensing of the food or beverage product; this also constitutes a safe way of avoiding that the plug or the bond fall in the product.

According to another embodiment of the invention, the weakened area 122 can also be made as a hinge, in which case the primary closing plug 127 will detach from the primary outlet section 300 by rotation over one of the sides of the hinge. FIG. 6 shows the case where the opening in the primary outlet section 300 is done in an essentially horizontal way, parallel to the longitudinal configuring axis 500 of the fitment assembly 10: however, another possibility would be to open the primary outlet section 300 in a slanted way, the opening forming an angle with respect to the longitudinal configuring axis 500.

Preferably, the dispensing outlet 120 further comprises a secondary weakened area 132 arranged vertically higher over the primary weakened area 122. Typically, the dispensing outlet 120 comprises two sections having different diameters: a primary outlet section 300, having a primary outlet diameter 129, and a secondary outlet section 400, having a secondary outlet diameter 139. Preferably, the primary outlet diameter 129 is smaller than the secondary outlet diameter 139. The primary outlet diameter 129 is accessed once the primary weakened area 122 is cut and the primary closing plug 127 is removed, hanging from the primary bond 128. The first access is done by a first level of opening, marked as 129a in FIG. 6.

The secondary weakened area 132 is made as a narrowing of the secondary outlet section 400, and is typically cut and opened after the first delivery from the primary outlet section 300 has finished. This secondary weakened area 132 can be either opened by being cut or can also be preferably configured as a hinge, so that the secondary outlet section 400 detaches from the primary outlet section 300 by rotation on one of the sides. Typically, the secondary weakened area 132 comprises a primary hinge element 132a and a secondary hinge element 132b, so that it opens by rotation of a second level of opening 139a, over the remaining secondary outlet section 400. Besides, a secondary bond 138 is provided between the first level of opening 129a and the second level of opening 139a, so that, once the secondary weakened area 132 is cut, rotation of the second level of opening 139a, over the remaining secondary outlet section 400, occurs by pivoting over the primary hinge element 132a with the help of the secondary bond 138 which is fixed to the fitment assembly 10. This rotation leaves open the secondary outlet section 400 for dispensing food or beverage product. The fact that there are two hinge elements, 132a and 132b makes it possible that the dispensing outlet 120 can pivot over any of them.

Preferably, according to the invention, the primary bond 128 and the secondary bond 138 comprise weakened parts (see for example FIG. 6) allowing that, once the first level of opening 129a and the second level of opening 139a have been opened (either by being cut or by rotation around a hinge configuration), the bonds lose their elasticity and therefore cannot go back to their original positioning, so that they do not interfere with the food or beverage product dispensing. In fact, these weakened parts of the bonds allow that they rotate around these parts in a similar was as a hinge does: because these parts are weakened, they do not come back to their original positioning either.

Typically, for example when long beverages are dispensed from the pack 100, first dispensing is done by the primary outlet section 300, during a certain time, this section having a lower diameter which allows to get better quality of the dispensed product, such as for example obtain a good foaming of it. After this first dispensing, the opening of the secondary outlet section 400 takes place which leaves open a higher diameter for a quick dispensing of the remaining product. Therefore, by making the dispensing in these two steps, a primary step will allow producing enhanced properties, preferably foaming, of the product, and the secondary step will provide quicker dispensing of higher volume. The total dispensing time needed for obtaining a high quality food or beverage product in a reduced amount of time, preferably when targeting long beverages, compared to standard delivering.

The fitment assembly 100 can also be provided with more than one dispensing outlet, typically with two dispensing outlets: in this case, at least one or the two dispensing outlets can be provided with a configuration as the one just described.

According to the invention, there are two possible embodiments for the configuration of the second level of opening 139a, as shown in FIGS. 6, 7a and 7b: a first embodiment would be to have the second level of opening 139a horizontal, parallel to the longitudinal configuring axis 500 of the fitment assembly 10 (FIG. 6); a second embodiment would be to have the second level of opening 139a oblique, forming an angle α with respect to the longitudinal configuring axis 500 of the fitment assembly 10 (FIGS. 7a and 7b).

The primary outlet diameter 129 and the secondary outlet diameter 139 have a transverse section with a surface area equivalent to the surface of a circular surface of diameter of at least 1 mm, preferably at most 4 mm, more preferably comprised between 1.5 and 3 mm, and even more preferably comprised in the range of around 2 mm.

When a thick beverage or food product is intended to be produced and dispensed from the pack 100 of the invention, for example beverages or food products having pulp or thicker elements, the primary outlet diameter 129 and the secondary outlet diameter 139, preferably the secondary outlet diameter 139, will have a transverse section higher than 5 mm, preferably in the range of around 6 mm.

The dispensing outlet 120 is typically configured as a straight tube oriented essentially vertically in the fitment assembly 10, having a length preferably of at least 5 mm. Such a length generally enables a finalisation of the froth of the product, typically a beverage, before it is delivered in a drinking cup. An advantage of the dispensing outlet 120 of the present invention is that there is no need to implement a particular connection between it and the machine when a beverage is for example produced, in order to direct the flow of the beverage delivered from the dispensing outlet: the beverage can flow from the dispensing outlet 120 directly into a drinking cup.

According to the invention, before the food or beverage preparation step, the dispensing outlet 120 is closed at its end by means of the primary closing plug 127. Generally the dispensing outlet is closed by manufacturing and is configured for being opened at food or beverage production step. By “closed by manufacturing” it is meant that a complete pack, comprising the container 20 and the fitment assembly 10, is manufactured with closed dispensing outlet 120. This closure guarantees hygienic and shelf life protection. The dispensing outlet 120 can be opened by a food or beverage preparation machine or manually.

Preferably the pack 100 is not pressurized during the beverage or food preparation. This effect can be obtained by opening the dispensing outlet 120 before water is introduced in the pack or simultaneously to the introduction of the water in the pack or a little bit after the introduction of the water in the pack. Globally the beverage or food product is prepared with both the fluid inlet 110 and the dispensing outlet 120 being opened.

Preferably the primary closing plug 127 is part of one single fitment assembly 10 comprising the dispensing outlet 120 and the fluid inlet 110. In particular when the fitment assembly 10 is made by injection moulding, the design of the mould also comprises the plug 127. In the same manner the primary and secondary bonds 128, 138 can also be part of the design of the fitment assembly 10 when it is made by injection moulding, which again provides advantages from a manufacturing point of view, as the same part comprises the fluid inlet 110, the dispensing outlet 120, the primary closing plug 127 and the bonds 128, 138.

Preferably, the fluid inlet 110 is piercable by piercing means 30, typically piercing and injecting means, called in what follows piercing means, comprised in a food or beverage preparation machine. The piercing means 30 typically have two functions: they pierce the lid or external cover typically arranged outside the fluid inlet 110, and they also inject fluid at pressure into the fluid inlet 110. Preferably, the piercing means 30 comprise a fluid needle, called in what follows needle, typically a water needle: these piercing means 30 typically comprise an inner duct or pipe through which high pressure fluid is injected in the fluid inlet 110. These needles can have any kind of external shape or configuration, as the main requirement is that they pierce the external lid properly and that they can inject fluid at the desired pressure. Preferably, fluid is injected at a pressure higher than 2 bar, more preferably higher than 3 bar. Preferably, the fluid is injected at a pressure comprised in the range between 2 and 10 bar, more preferably around 7 bar. The fluid inlet 110 is configured in such a way that the high pressure fluid injected through it by the piercing means 30 is converted into a high velocity jet 6, which is driven into the inner volume of the container 20. Typically, the fluid inlet 110 comprises a yieldably piercable cover or lid over it, typically configured by the flexible sheets of the container 20 laid over it, which can be pierced by the piercing means 30 of the machine once the preparation of the food or beverage product starts. The piercing means 30 preferably also comprise a toroidal ring, preferably made of rubber, ensuring that there is no leakage of fluid outside the fluid inlet while the piercing means 30 are injecting fluid into the fluid inlet. The fluid inlet 110 is communicated with the inside volume of the container 20 through an injection hole 111 which has a diameter of at most 1 mm, more preferably of at most 0.6 mm, preferably of at least 0.24 mm, preferably comprised between 0.3 mm and 0.5 mm, more preferably of about 0.4 mm, which is particularly adapted when the fluid is delivered at the fluid inlet 110 at a pressure comprised between 2 and 10 bar. With such a configuration, the high pressure fluid injected by the piercing means 30 is conveyed internally in the fluid inlet 110 towards the injection hole 111, from which it is converted into a high velocity jet of fluid injected inside the inner volume of the container 20 when passing through the small section of the injection hole 111. Typically, this jet of fluid provided in the container 20 has a velocity of at least 20 m/s, depending on the diameter of the injection hole 111. The shape of the small section of the injection hole 111 can be of any kind; however, circular section is preferred for easy manufacturing.

The fluid inlet 110 presents an inlet chamber 112 at its entrance configured as a hollow cavity, which is globally horizontally oriented. Its dimensions are configured for receiving the piercing means 30, typically configured as a hollow needle of a beverage preparation machine in order to allow that a fluid, preferably water, is injected in the fluid inlet 110. The inlet chamber 112 presents an evacuation end preferably arranged in its upper lateral wall corresponding to an injection hole 111 from which water can be injected in the inner volume under the form of jet 6. The hole is typically circular. Due to the configuration of the fluid inlet 110 the water can be injected essentially horizontally in the inlet chamber 112 and essentially vertically in the inner volume of the pack.

The fluid jet which is created inside the container 20 avoids that the food or beverage product flows through the dispensing outlet too rapidly: therefore, the time of agitation of the ingredient together with the fluid inside the container volume is increased.

By jet it is understood a stream of liquid or fluid that comes out of the fluid inlet and into the inner volume of the food or beverage container quickly and with force. Therefore, the fluid inlet 110 is configured for introducing fluid in the inner volume of the container 20 with a high velocity, this fluid jet preferably presenting a velocity of at least about 20 m/s, preferably at least 30 m/s. As previously described, such a configuration is preferably obtained in the present invention by placing a constriction (that of the injection hole) in the fluid path in the fluid inlet to reduce the size of the section of the fluid inlet. Due to the small surface of the injection hole through which the fluid goes into the inner volume of the container, the pressurized fluid creates a jet in the inner volume of the container 20.

According to the invention, the fluid inlet 110 can also be configured for providing an orientable high velocity jet into the container 20, preferably at about 90° with respect to the fluid supply provided into the fluid inlet 110 by the piercing means 30, though any other angle would be possible and comprised within the scope of the present application.

The small surface of the injection hole 111 presents the advantage of avoiding any back flow of fluid from the inner volume of the container 20 into the fluid inlet 110. For the same fluid to be provided through the fluid inlet 110, the surface of the injection hole 111 can vary according to the nature of the food and beverage ingredient inside the container 20 which is to be mixed with the fluid. In particular when the ingredient is difficult to dissolve a smaller injection hole 111 creates a jet with a higher velocity which improves agitation and dissolution of this ingredient in the container 20.

The pack 100 of the invention can be provided with the same fitment assembly 10 but with different sizes of containers 20, typically varying in their height or vertical length. Different food or beverage ingredients can be stored inside the pack 100, so it becomes possible to produce different products, such as for example a cup of espresso coffee or a bowl of soup. The external design and configuration of the fitment assembly 10 will remain unchanged independently on the product targeted; however, the internal design of the fitment assembly 10, in particular as to the diameter of the injection hole 111 will differ as a function of the ingredient to be processed and therefore as a function of the food or beverage product targeted. Also, other parameters will be varied as a function of the food or beverage product targeted, typically the fluid flow rate injected by the injection means into the fluid inlet 110, the temperature of the fluid injected and/or the total volume of fluid injected. These parameters will be provided by the food or beverage preparation machine. Other process parameters can be for example pulse parameters like duration of jet phase and pause in between jet phases. As the dispensing process made from the pack 100 when the dispensing outlet 120 comprises a primary outlet section 300 and a secondary outlet section 400 is typically made in two phases or steps (first that with the primary outlet section 300 and then the one with the secondary outlet section 400), these parameters will be provided for each of the phases: these parameters can therefore be changed and optimized for each of the phases depending on the targeted result.

According to the invention at least two types of packs essentially differing by their ability to produce a foamy beverage or a non-foamy beverage will be provided. The first type of pack that is able to produce a foamy beverage generally presents a fluid inlet configured for introducing a water jet 6 in the inner volume of the pack with a higher velocity than the second type of pack. The first type of pack also preferably presents a shape configured for improving the movement of the fluid and the beverage in the container during beverage or food preparation. It has been observed that rectangular containers presenting a ratio length/width of about 4/3 and with the fitment assembly 10 placed at the width side improve the agitation of the fluid and the generation of foam. This effect is even more accentuated when the fitment assembly 10 is positioned at the side corner of the width with the length. The foaming of the beverage can also depend on the nature of the food or beverage ingredient. The invention enables the production of a range of different packs adapted for the agitation and dissolution of different types of beverage or food ingredients comprised in the containers. As already described previously, foaming is also enhanced by the use of a first dispensing of the product through a primary outlet section 300 having a smaller diameter than that of the secondary outlet section 400.

The pack 100 can also comprise an excrescence (not shown) enabling the handling of the pack 100 by the user or consumer, typically on the top edge 214 of the pack or on one of the lateral edges 212, 213.

The fluid inlet 110 is typically enclosed in the complete pack 100 by the sheet(s) of material defining the inner volume of the container 20: the yieldable cover over the fluid inlet 110 piercable by the piercing means 30 of the machine is therefore made by the sheets of material covering this fluid inlet 110, so it is not necessary to prepare any supplementary cover or membrane to go over it, the manufacturing being easy and convenient. Consequently the same piece of material can be used to simultaneously create the inner volume of the container 20 and to close the fluid inlet 110. As such, the invention provides a pack 100 that is easy to manufacture and which guarantees hygienic and shelf life protection of the food and beverage ingredients and of the produced food or beverage product.

Preferably, the introduction of the fitment assembly 10 in the bottom edge of the container 20 during the sealing of its edges to configure the complete pack 100 makes it possible that the flexible sheet can cover the part of the fitment assembly 10 including the fluid inlet 110. Consequently during the single step of bonding the edges of the sheet, it is possible to simultaneously create the inner volume for storing the food or beverage ingredient, place the fitment assembly 10 and close the fluid inlet 110. Preferably the dispensing outlet is not covered by the sheets. Yet it can be visually hidden by a part of the sheet e.g. by a skirt of the sheet. Also preferably, according to the invention, the fitment assembly 10 comprises ribs 16 arranged in at least one of the external surfaces of the fitment assembly 10 for improving the adhesion of the fitment with the flexible material sheet during sealing. In particular a raising edge can surround the fluid inlet so as to improve air and water tightness around it.

According to the invention, either the fitment assembly 10 and/or the food or beverage container 20 preferably comprise identification means 60 comprising the information of the parameters for the fluid supply into the fluid inlet 110, at least one or a combination of: flow rate of fluid supplied into the fluid inlet 110, temperature at which the said fluid is supplied into the fluid inlet 110, total volume of fluid introduced in the fluid inlet 110. Other process parameters can be for example pulse parameters like duration of jet phase and pause in between jet phases. Moreover, these identification means 60 typically comprise the information of the phases to be carried out with the pack of the invention: length in time of each of the phases and process parameters (as cited before) for each one of these phases.

The fluid can be supplied in the fluid inlet 110 at any temperature, cold, ambient or hot, depending on the type of food or beverage product targeted. Such identification means 60 can comprise any kind of recognition means such as, for example, mechanical codes, optical codes, RFID tags, magnetic tags, bar codes, magnetic codes, punched holes, perforations, or the like.

A preferred way of configuring the identification means 60 is to make them as detection holes on one lateral edge of the food or beverage container 20 in the area of the flexible sheets being bonded together where there is no food or beverage ingredient preventing the arrangement of these detection holes, as schematically illustrated in FIG. 1. When the two sheets are brought together and are welded on the edges to configure the container 20, on one of these lateral edges, additional welding with circumferential shape will be provided, thus configuring the detection holes by punching. Another way could be to reproduce several times a miniature code printed on the surface of the sheet of material, for example.

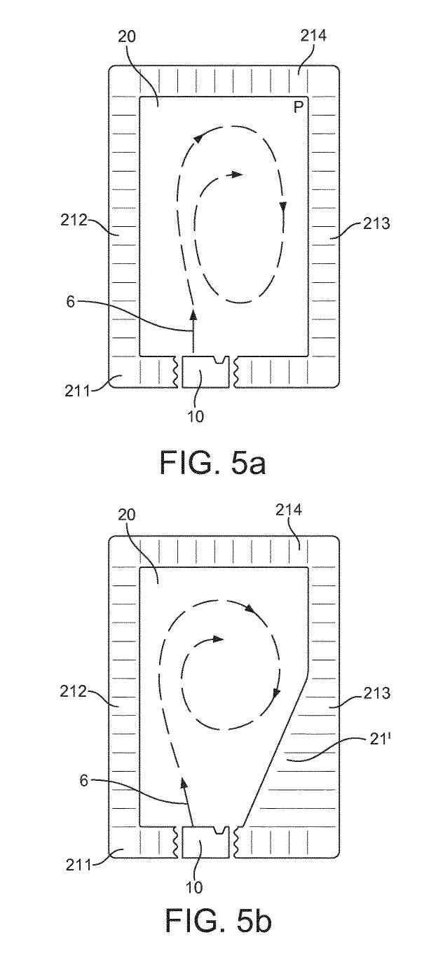

Preferably, according to the invention, the pack 100 presents a plane shape oriented along a plane P essentially vertically oriented during beverage production and the fluid inlet 110 orientates the jet 6 of fluid in a direction comprised in said plane. The fluid jet introduced from the bottom into the inner volume of the container 20 is developing into circular and spiral movements creating turbulences, frictions and high contact surfaces between the fluid molecules (typically, water molecules) and the ingredient particles. In average the fluid molecules have several turns within the container until they leave it together with the beverage or food product once mixed. Best results (reconstitution) have been observed with a pack of rectangular shape. Packs with a fitment assembly placed in the corner of a rectangular pack have also been found to improve reconstitution. This is schematically illustrated in FIG. 5a.

Also as shown in FIG. 5b, the food or beverage container 20 preferably comprises at least one, more preferably two sloped areas 21′ symmetrically arranged presenting slanted shapes in the vicinity of the fitment assembly 10 converging towards the fitment assembly 10, which enhance and facilitate the dispensing of all the product inside the container through the dispensing outlet 120 such that a minimized quantity of it can be left inside the container 20, therefore avoiding that beverage or food ingredients remain blocked in these corners. The sloped areas 21′ can be obtained by sidewise sealing the corners of the containers. The food or beverage containers 20 can present various external shapes like rectangular, square or round shapes. The inner volume of these containers would preferably present a shape configured for improving the movement of the fluid and the food or beverage ingredient in the container during product preparation.

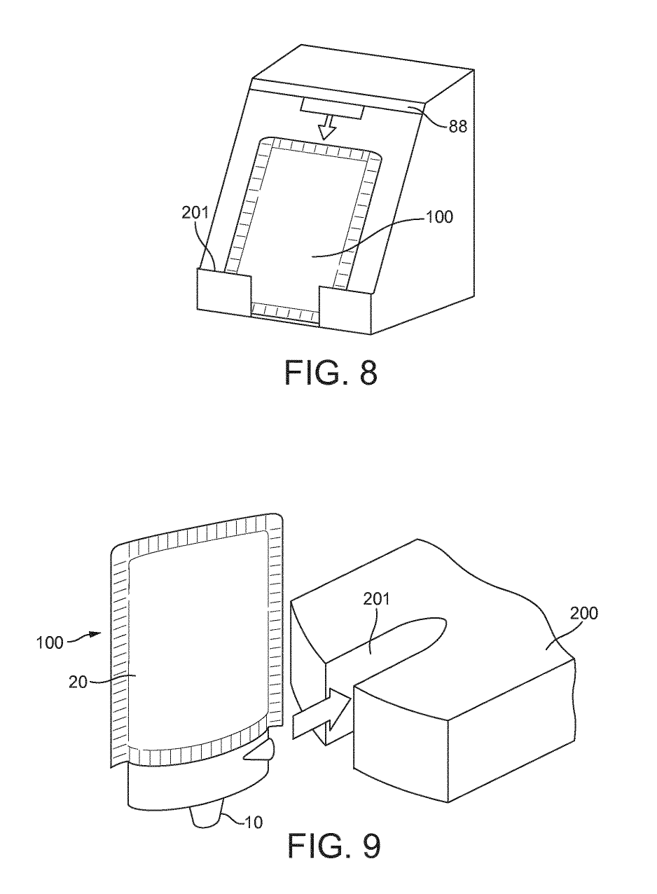

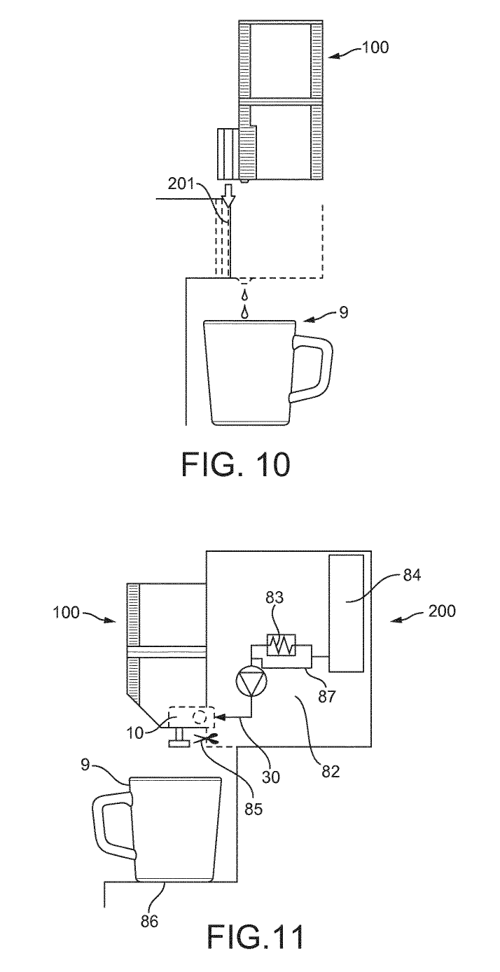

According to another aspect, the invention refers to a food or beverage preparation machine 200 for preparing a food or beverage product from a pack 100 as described previously. The machine 200 comprises receiving means 201 adapted to accommodate the pack 100 preferably in such a way that the pack 100 is positioned vertically and the fitment assembly 10 is positioned at the bottom of the pack 100. The machine 200 further comprises piercing means 30 designed for engaging with the fitment assembly 10 and for injecting high pressure fluid inside the fluid inlet 110 of the fitment assembly 10. Typically, as the pack 100 is processed to obtain the beverage or food product in an essentially vertical position in the machine 200, the pack 100 will be introduced either frontally in the machine 200 (as schematically represented in FIG. 8) or laterally, so that the pack 100 is slidably inserted into a dedicated insert in the machine 200 (as schematically represented in FIG. 9 or 10).

FIGS. 8, 9 and 10 illustrate examples of the receiving area 201 in the food or beverage preparation machine 200 for the pack 100 according to the present invention. FIG. 9 illustrates the introduction of the pack 100 in the machine 200 according to a globally horizontal sliding movement whereas FIG. 10 illustrates the introduction of the pack 100 according to a vertical sliding movement and FIG. 8 illustrates the simple positioning of the pack on a slightly slanted plane and the closure of a sliding cover 88—e.g. a transparent cover—above the pack to launch the beverage preparation. Other configurations of the receiving area 201 and other movements are possible depending on the positions of the fluid inlet 110 in the pack 100 (horizontally or vertically oriented, perpendicular to or inside the main plane of the pack) and on the position of the fitment assembly 10 in the pack 100 (in the corner, in the middle of the bottom).

FIG. 11 illustrates the interaction of a pack 100 according to the present invention with a food or beverage preparation machine 200. As illustrated, the machine 200 comprises at least:
a fluid tank 84,
a heater 83 for heating the fluid
a bypass line 87 for delivering fluid at ambient temperature,
a valve (not illustrated) for the selection of either hot or ambient fluid,
a pump 82 for pumping fluid,
optionally, a cooling unit (not shown) can also be provided in the machine 200 for delivering cold fluid,
piercing means 30 for injecting fluid in the fluid inlet 110 and optionally for piercing the external lid over the fluid inlet 110.

The machine 200 also comprises a data reader, preferably comprising an optical device, which reads and retrieves the information from the identification means 60 regarding the process parameters to be used for preparing the food or beverage product from the pack 100. Preferably, the process parameters used by the machine 200 to prepare the correct recipe of the product in the pack 100, retrieved by the data reader, would be at least one or a combination of: temperature of the fluid (typically water) introduced by the piercing and injecting means in the inlet chamber 120; total volume of water introduced in the inlet chamber 120; and water flow provided through the piercing and injecting means also into the inlet chamber 120. Other process parameters can be for example pulse parameters like duration of jet phase and pause in between jet phases. These parameters will be provided for each one of the phases to take place when preparing the food or beverage product from the pack 100.

Preferably, the data reader will retrieve the information from the identification means 60 in the pack 100 by a light emitter device emitting light passing through punched holes configuring in a preferred embodiment the identification means 60. Another possible embodiment would be to use a printed code reader.

Preferably the machine comprises a positioning area 86 for allocating a drinking cup 9 under the dispensing outlet 120 of the pack 100 when a food product or a beverage is prepared.

Also preferably, the machine 200 further comprises a cutting device 85 for cutting the primary closing plug 127 of the dispensing outlet 120 of the pack 100. The cutting device 85 can be positioned so that the closing plug 127 of the dispensing outlet 12 is automatically cut when the pack 100 is introduced in the machine 200 or when the food or beverage preparation is activated. The cutting device 85 is also dedicated for cutting the second level of opening 139a in order to leave open the secondary outlet section 400.

FIG. 1 illustrates a possible embodiment of the fitment assembly 10 wherein the inlet 110 and the outlet 120 are holes inside one same fitment assembly 10, the fluid inlet 110 being arranged essentially perpendicularly with respect to the injection hole 111. Such a fitment assembly 10 enables cooperation with a beverage machine presenting a configuration such as described in FIG. 11. The pack 100 presents a generally plane shape, being oriented along a plane P essentially vertically oriented during beverage production when the piercing means 30 of a beverage preparation machine are introduced in the fluid inlet 110. The pack can be almost flat in the direction perpendicular to plane P.

Due to the orientation of the pack 100 the food or beverage ingredient usually stands at the bottom of the inner volume of the container 20 when the pack 100 is in position for beverage preparation. Consequently when water is introduced in the fitment assembly 10 next to the bottom of the pack 100 it immediately penetrates the food or beverage ingredient and agitates it. The dissolution starts very rapidly. Moreover as the beverage or food issued from the dissolution of the ingredient with water flows down in the pack then said beverage or food is agitated again as long as water is introduced in the pack.

Preferably, the fluid inlet 110 is configured so as to create a jet of water inside the inner volume of the container 20 through the injection hole 111. The fluid inlet 110 is configured for introducing the water jet 6 in the inner volume of the pack at a high velocity.

This velocity aims at:
agitating the food or beverage ingredient in the inner volume of the pack,
maintaining the circulation of the food or beverage ingredient, the water and the resulting beverage in the inner volume and avoiding that food or beverage ingredient is dispensed by the dispensing outlet 120 before it has been sufficiently agitated and dissolved.

Depending on the nature of the food or beverage ingredient the high velocity water jet 6 can create an emulsion with the water and the fats or oils issued from the ingredients. As a result a beverage with particular good mouth feel can be obtained. In the case of production of a coffee espresso, a coffee with crema can be directly obtained from the pack without adding particular foaming additives in the beverage ingredient or without post treating the beverage to get the desired crema.

According to the invention, a water jet 6 presenting a velocity of at least 20 m/s enables an optimal dissolution of food or beverage ingredient in the inner volume. A jet of water with high velocity can be created in the inner volume by injecting water through a small orifice (that of the injection hole 111). The fluid inlet 110 can present a small section along all its length or it can present a constriction presenting such a small section. Usually this last implementation is preferred. The size of the section to get a jet of water in the inner volume usually depends from the pressure of the water introduced in the fluid inlet 110 by the food or beverage preparation machine.

The velocity of the water jet 6 emerging from the injection hole 111 usually depends on the pressure of the water introduced at the fluid inlet 110. The invention generally applies for water pressurised between 2 and 10 bar, preferably at about 7 bar. For such values of pressurized water the injection hole 111 presents a transverse section with a surface area equivalent to the surface of a circular surface of diameter comprised between 0.2 and 0.8 mm, preferably between 0.3 and 0.5 mm and even more preferably of about 0.4 mm. However, when water is pressurized at more than 11 bar the injection hole 11 presents a transverse section with a surface area equivalent to the surface of a circular surface of diameter comprised between 0, 5 and 1, 5 mm, preferably of about 1 mm.

For the same diluent supply pressure the surface of the injection hole 111 can vary according to the nature of the food and beverage ingredient inside the pack 100. In particular when the ingredient is difficult to dissolve a smaller injection hole 111 creates a jet 6 with a higher velocity which improves agitation and dissolution of the ingredient in the pack.

FIGS. 5a and 5b illustrate the movement of the liquid in the inner volume of a pack 100 in the main plane P. The pack 100 presents lateral and bottom sealed edges 211, 212, 213. The bottom sealed edge 211 has been made partly transparent to show the fitment assembly 10 comprising the fluid inlet 110 and the dispensing outlet 120. In such a pack the water jet 6 emerges with high velocity from the fluid inlet 110 placed at the bottom, then flows upwardly and develops in a circular and spiral movement inside the main plane P of the pack. Due to this movement the liquid in the inner volume is not directed to the outlet 120 and keeps moving according to this movement, which enables agitation and optimised dissolution of the food or beverage ingredient. After a certain delay of time, the food or beverage flows out of the pack through both of the dispensing outlet 120, at different phases or steps. The section of the dispensing outlets is sufficiently large to create a gentle flow in the dinking cup placed under the outlets and receiving the food or beverage product. The pack totally empties due to the position of the outlets next to the bottom of the pack.

FIG. 5b illustrates a pack 100 according to the invention presenting an optimised internal shape of its inner volume. It presents the same feature as the pack of FIG. 5a except that the seal on the lateral edge 213 is made larger at the bottom corner of the pack so as to configure the inner volume with a sloped area 21′ in an internal corner of the container. The water jet 6 emerging from the injection hole 111 develops in a circular movement and the slanted edge reinforces this movement alive by reorienting the movement upwards when it comes downwards. Such an embodiment can be particularly interesting for food or beverage ingredients that are difficult to dissolve and that must be strongly agitated. This configuration also enables to guide and push all the dose of food or beverage ingredient above the fluid inlet 110 in the inner volume of the pack. Then the contact between the food or beverage ingredient and water is improved at the point where the water flow presents its higher velocity and agitation strength.

Although the bottom corner is represented in FIG. 5b as completely internally sealed, it is also possible to create a simple sealing line inside the inner volume of the pack to prevent liquid from circulating in the corner.

According to yet another possible embodiment of the invention, the fitment assembly 10 can further comprise an evacuating liquid outlet 600 (see FIGS. 4a-b) for evacuating any liquid from the inner pack in case of need or emergency: the evacuating liquid outlet 600 consists of a large hole communicating with the large hollowed out volume at the upper surface of the fitment assembly 10. This large hole decreases the risk of presence of blocking elements in this area and guarantees a good evacuation of the liquid from the pack through the evacuating liquid outlet in case of emergency. Typically, the flexible sheet laid over the fluid inlet 110 is also laid over the evacuating liquid outlet, which will be pierced by the piercing means 30 in case of emergency. Even when FIGS. 4a-b show the fitment assembly 10 comprising an evacuating liquid outlet 600 it is possible that the fitment assembly 10 does not comprise it.

FIG. 2 illustrates a method for manufacturing a pack 100 according to the invention from a flexible sheet of material, which typically comes from a roll. First the sheet of material that preferably presents a rectangular shape is folded in its middle and the superposed lateral edges are bonded together which creates pouch with bonded lateral edges 212, 213 and a folded edge 214. The folded edge 214 can also eventually be sealed to give a comparable aspect as the lateral edges for aesthetic aspect. Then food or beverage ingredient is introduced in the pouch. Then the fitment assembly 10 is placed between the two last opened edges and these edges are bonded together and around the fitment assembly 10 to simultaneously close the pack, position the fitment and close the fluid inlet 110. According to a less preferred embodiment the fluid inlet and the dispensing outlets can be made in separate part or inserts.

Whatever the above described embodiments the fluid inlet 110 can be oriented in the pack 100 according to two different variants, as it will be further explained now.

According to one first variant the fluid inlet 110 can be positioned in the pack 100 so that it is almost totally essentially vertically oriented during the beverage production. Then the fluid inlet 110 can be placed at any part along the bottom of the pack 100. Usually according to this first variant the fluid inlet 110 is a straight tube, preferably in an insert positioned at the bottom of the pack 100. The insert can be positioned between two flexible water impermeable sheets 21, 22 joined to one another and forming the inner volume. In this first variant the fluid inlet 110 and the dispensing outlet 120 are usually globally parallel vertically oriented tubes.

According to a second variant the fluid inlet 110 can be at least partially essentially horizontally oriented during beverage production. In this second variant the fluid inlet 110 and the dispensing outlet are globally perpendicular one with respect to the other. According to this second variant the fluid inlet 110 is generally positioned in one lateral side of the pack 100 and next to the bottom of said lateral side (see for example FIG. 1).

In a first mode of this second variant the fluid inlet 110 can be an almost straight tube in an insert; accordingly the fluid inlet 110 is configured so that there is no change of direction of the flow water in the fluid inlet 110 to the injection hole 111. Said insert is preferably positioned between the two flexible water impermeable sheets 21, 22 joined to one another.

In a second mode of this second variant the fluid inlet 110 can be configured so that the direction of the water flow in the injection hole 111 is almost perpendicular to the direction of the water flow injected in the fluid inlet 110. In this embodiment the internal design of the fluid inlet 110 enables a globally perpendicular change of orientation of the water flow from the fluid inlet 110, facing the external part of the pack 100, to the injection hole 111, facing the internal part of the pack 100.

In said second mode the external end of the water inlet preferably comprises an inlet chamber 112 which comprises an evacuation end, said evacuation end being an injection hole 111 configured for directing a jet of water 6 in the inner volume of the pack 100 in a direction almost perpendicular to the longitudinal axis of the inlet chamber 112. Preferably the inlet chamber 112 is globally horizontally oriented. This chamber is usually configured for receiving a hollow needle for injecting water, typically configuring the piercing means 30. It generally presents a circular section. This chamber presents the advantage of creating a distance between the end of the hollow needle and the inner volume which stores the food or beverage ingredient and consequently avoids the contamination of the needle. The evacuation end can be configured for delivering water under the form of a jet 6 in the inner volume of the pack 100 as described in the above first embodiment. Most preferably the chamber evacuation end is a hole pierced in the lateral wall of the chamber, configuring the injection hole 111.

It is preferred that the pack 100 presents a generally plane shape essentially vertically oriented during food or beverage production. According to the present second mode of the second variant for the fluid inlet 110 the inlet chamber 112 is preferably perpendicular to said plane. Then the fluid inlet 110 and the dispensing outlet are generally perpendicularly oriented with respect to each other. Consequently the inlet and the outlets emerge on different sides of the pack 100. This configuration limits the contamination risk of the means for introducing water in the fluid inlet 110 by the beverage dispensed by the dispensing outlet 120.

Still, the most preferred embodiment of the invention is to have the fluid inlet 110 and the dispensing outlet 120 in the same fitment assembly, the fluid inlet 110 being arranged frontally, transverse to the longitudinal configuring axis 500 of the fitment assembly, and perpendicular to the dispensing outlet 120, which is typically arranged as a straight vertical tube parallel to the sheets of material configuring the container 20 and parallel to the plane P.

Whatever the variant and the mode for the fluid inlet 110 said fluid inlet 110 can be also configured for orienting the water jet 6 in direction of the dispensing outlet 120. Such a configuration enables the agitation of the food or beverage by the water jet 6 before it evacuates through the dispensing outlet 120. According to a particular mode the packs 100 designed for producing a jet of water 6 that is globally horizontally oriented are particularly interesting for avoiding the clogging of the food or beverage ingredient. The water jet 6 avoids that the food or beverage flows through the outlets too rapidly and increases the time of agitation of the ingredient in the pack 100.

Different embodiments of the pack 100 described here above can be combined together and would still be comprised within the scope of the present patent application.

The invention also refers to a range of packs such as described here above wherein the packs differ by the size of the inner volume and/or the internal dimension of the outlet and/or the internal dimension of the inlet and/or the orientation of the inlet and/or the orientation of the outlet. A wide range of different sachets can be used for producing different types of food or beverages. The external design of the fitment assembly 10 remains the same whereas the inner volume of the pack (with respect to vertical size or height) can be adapted to store different quantities of ingredients. It becomes possible to produce a cup of espresso coffee or a bowl of soup. The internal design of the fitment assembly 10 can be adapted according to the nature of the food or beverage ingredient inside the pack 100.

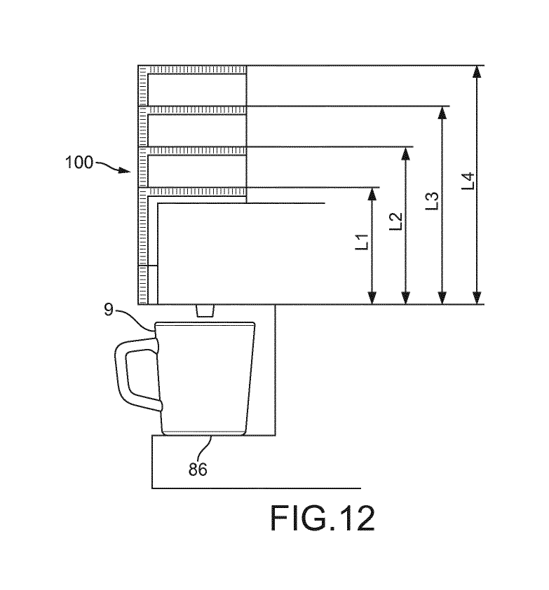

FIG. 12 illustrates the possibility to create a range of packs with the same fitment assembly 10: it is therefore possible to produce a range of packs differing by the size of the inner volume (L1, L2, L3, L4) and configured for preparing a food or beverage product with the same food or beverage preparation machine.

Furthermore, the invention also refers to a method for preparing a food or beverage product from a pack 100 as described before, and using a food or beverage preparation machine 200, comprising the following steps:
providing a pack 100 such as described previously or a pack from a range of packs such as described here above and positioning said pack with the fitment assembly 10 positioned downwardly;
injecting water into the pack 100 to mix with the food or beverage ingredient;
allowing the prepared beverage or food product to escape through the dispensing outlets into a receptacle.

As already explained previously, the preparation and dispensing of the food or beverage product comprised in the pack 100 is done typically in two phases. For each one of the phases, the identification means 60 provide the machine 200 with the information on the time that each phase lasts and, with the process parameters to be followed in each phase, which are at least one or a combination of: temperature of the fluid (typically water) introduced by the piercing and injecting means in the inlet chamber 120; total volume of water introduced in the inlet chamber 120; and water flow provided through the piercing and injecting means also into the inlet chamber 120; duration of jet phase and pause in between jet phases. Preferably, the first phase will dispense product by the primary outlet section 300 and the second phase will dispense product by the secondary outlet section 400. The diameter of the primary outlet section 300 is preferably lower than that of the secondary outlet section 400, so the first phase will typically produce a high quality foamed product and the second phase will dispense the higher volume to complete the food or beverage product targeted.

Preferably the method is implemented by a food or beverage preparation machine 200 in which the different steps and process phases are implemented. Water is generally injected by piercing the pack 100 with a hollow needle at the fluid inlet 110 of the pack 100.

The packs 100 of the invention, as described previously, present several advantages, as will be detailed in what follows herewith.

The present invention presents the advantage of proposing packs 100 for the preparation of food or beverages wherein a broad range of different foods and beverages can be produced with the same machine. The foods and beverages can differ by their natures (coffee, tea, chocolate, soup, etc.), by their aspects (presence of crema for coffee, of foam for milk and chocolate, absence of bubbles for tea, etc.), by their volumes (from espresso volume up to soup volume) and be obtained by the same machine. The machine elements can remain very simple and limited to a simple water needle.

One of the main advantages of the packs of the invention is also that they allow a quick and high quality dispensing of food or beverage products, even long beverages or thick products.

The present invention presents the advantage of proposing a consumer friendly preparation of foods and beverages. The beverage of food delivered from the pack is ready to be served and does not require an additional process step, for example for foaming the beverage.

The present invention presents the advantage of proposing packs wherein the ingredients are fully protected from atmosphere before use.

The present invention presents the advantage of proposing packs for preparing beverages wherein the contact of ingredients and prepared beverage with the machine is avoided and the risk of cross contamination is limited. The prepared beverages present optimal organoleptic properties.

The present invention presents the advantage of proposing packs presenting a low environmental impact since it can be made of a laminated pouch with a small insert piece of plastic.

The present invention presents the advantage of proposing packs of global similar shapes but with particular internal difference in order to deal with the preparation of various beverages from various food or beverage ingredients presenting different properties like difference of dissolution, ability to clog, difference of volume, etc.

This is one key element of temper evidence proof allowing the consumer to detect if the sachet has been tempered before.

The present invention presents the advantage of proposing packs which can be very easily produced starting from flexible sheets and one single insert, for the simplest embodiment. In particular the pack usually does not comprise an internal filter or membrane to be positioned in the inner volume during manufacturing.

Reduced manipulations to be done on the side of the consumer are also a big advantage on the user's side, achieving best in-cup results as process parameters are given by the identification means 60 in the pack 100.

The space needed for the consumer to store the packs 100 according to the invention clearly much less than that for typical capsule containers, for example.

Although the present invention has been described with reference to preferred embodiments thereof, many modifications and alternations may be made by a person having ordinary skill in the art without departing from the scope of this invention which is defined by the appended claims.

LIST OF REFERENCES

| | |
|---|---|
| 100 | Disposable pack |
| 211 | Bottom edge of pack |
| 212 | Lateral edge of pack |
| 213 | Lateral edge of pack |
| 214 | Top edge of pack |
| 60 | Identification means |
| 6 | Water jet |
| 10 | Fitment assembly |
| 110 | Fluid inlet |
| 120 | Dispensing outlet |
| 111 | Injection hole |
| 300 | Primary outlet section |
| 400 | Secondary outlet section |
| 129 | Primary outlet diameter |
| 139 | Secondary outlet diameter |
| 122 | Primary weakened area |
| 132 | Secondary weakened area |
| 127 | Primary closing plug |
| 128 | Primary bond |
| 138 | Secondary bond |
| 16 | Ribs of fitment assembly |
| 112 | Inlet chamber |
| 600 | Evacuating liquid outlet |
| 132a | Primary hinge element |
| 132b | Secondary hinge element |
| 129a | First level of opening |
| 139a | Second level of opening |
| 500 | Longitudinal configuring axis |
| 20 | Food or beverage container |
| 21 | Flexible sheet |
| 22 | Flexible sheet |
| 21′ | Sloped area |
| 200 | Food or beverage preparation machine |
| 9 | Drinking cup |
| 30 | Injecting means |
| 201 | Receiving area |
| 85 | Cutting device |
| 84 | Fluid tank |
| 83 | Heater |
| 87 | Bypass line |
| 82 | Pump |
| 86 | Positioning area |
| 88 | Sliding cover |

1. A pack having an inner volume in which a food or beverage ingredient is stored and in which a food or beverage product is produced when a fluid is introduced inside,
the inner volume being defined by sheets of material joined to one another at their edges and the inner volume presenting a generally plane shape defining a plane essentially vertically oriented during beverage production,
the pack comprising at least one fluid inlet for supplying a fluid in the inner volume and at least one dispensing outlet for delivering the food or beverage product from the inner volume, the fluid inlet and the dispensing outlet being positioned at the bottom of the pack and being at least partially positioned between two joined edges of the sheets of material,
the fluid inlet being oriented essentially perpendicularly to the plane defined by the inner volume,
the dispensing outlet being configured as an essentially parallel tube arranged essentially vertically from the inner volume, configured so as to enable a free flow of the food or beverage product form the pack,
the dispensing outlet comprising a primary outlet section and a secondary outlet section, the secondary outlet section being arranged vertically higher than the primary outlet section and having a greater diameter than that of the primary outlet section, the configuration allowing the sequential dispensing of the food or beverage product at least in two phases, a first phase where dispensing is done through the primary outlet section and a second phase where dispensing is done through the secondary outlet section.

2. A pack according to claim 1 wherein the dispensing outlet comprises a primary weakened area arranged in the primary outlet section and a secondary weakened area that allow the opening of the primary outlet section and of the secondary outlet section, respectively.

3. A pack according to claim 2 wherein the secondary weakened area is configured as a hinge, allowing the opening of the secondary outlet section by pivoting over the primary outlet section.

4. A pack according to claim 3 wherein the secondary weakened area comprises a primary hinge element and a secondary hinge element, such that the secondary outlet section can pivot over the primary outlet section by rotating over any of these hinge elements.

5. A pack according to claim 1 wherein the closing of the primary outlet section and the primary outlet section or the secondary outlet section are attached to the pack by use of a primary bond and a secondary bond, respectively.

6. A pack according to claim 1 wherein the secondary weakened area is configured such that it allows the detaching of the primary outlet section from the secondary outlet section in an essentially horizontal way.

7. A pack according to claim 1 wherein the secondary weakened area is configured such that it allows the detaching of the primary outlet section from the secondary outlet section in a slanted way, under a detachment angle.

8. A pack according to claim 1 wherein the diameter of the dispensing outlet is about 1 mm to 6 mm.

9. A pack according to claim 1 comprising a single fitment assembly comprising the fluid inlet and the dispensing outlet, the fitment assembly being positioned at the bottom of the pack and being partially positioned between two joined edges of the sheets of material.

10. A pack according to claim 1 comprising an evacuating liquid outlet which can be pierced for evacuating liquid from the inner volume of the pack.

11. A pack according to claim 1 wherein the fluid inlet is configured for providing an orientable high velocity jet into the inner volume of the pack.

12. A pack according to claim 11 comprising an identification member comprising the parameters information for the fluid supply into the fluid inlet for each one of the sequential dispensing phases, also comprising the information on the duration in time of each phase, these parameters being at least one or a combination of: flow rate of fluid, temperature of fluid supply, total volume of fluid introduced in the fluid inlet, and/or duration of the jet supplied and/or pause in between jets.

13. A method for preparing a food or beverage product from a pack having an inner volume in which a food or beverage ingredient is stored and in which a food or beverage product is produced when a fluid is introduced inside, the inner volume being defined by sheets of material joined to one another at their edges and the inner volume presenting a generally plane shape defining a plane essentially vertically oriented during beverage production, the pack comprising at least one fluid inlet for supplying a fluid in the inner volume and at least one dispensing outlet for delivering the food or beverage product from the inner volume, the fluid inlet and the dispensing outlet being positioned at the bottom of the pack and being at least partially positioned between two joined edges of the sheets of material, the fluid inlet being oriented essentially perpendicularly to the plane defined by the inner volume, the dispensing outlet being configured as an essentially parallel tube arranged essentially vertically from the inner volume, configured so as to enable a free flow of the food or beverage product form the pack, the dispensing outlet comprising a primary outlet section and a secondary outlet section, the secondary outlet section being arranged vertically higher than the primary outlet section and having a greater diameter than that of the primary outlet section, the configuration allowing the sequential dispensing of the food or beverage product at least in two phases, a first phase where dispensing is done through the primary outlet section and a second phase where dispensing is done through the secondary outlet section comprising: at least two sequential steps, such that each step is defined by its length in time and at least by one or a combination of the following parameters: temperature of the fluid introduced in the inlet chamber; total volume of fluid introduced in the inlet chamber; fluid flow provided into the inlet chamber and/or duration of jet phase and pause in between jet phases.

14. Method according to claim 13 comprising two sequential phases, a first phase where the product is dispensed by the primary outlet section and a second phase where the product is dispensed by the secondary outlet section.

15. Method according to claim 13 wherein the preparation of the food or beverage product in the pack is done by a water jet presenting a velocity of at least 20 m/s.

16. Machine for preparing a food or beverage product from a pack having an inner volume in which a food or beverage ingredient is stored and in which a food or beverage product is produced when a fluid is introduced inside, the inner volume being defined by sheets of material joined to one another at their edges and the inner volume presenting a generally plane shape defining a plane essentially vertically oriented during beverage production, the pack comprising at least one fluid inlet for supplying a fluid in the inner volume and at least one dispensing outlet for delivering the food or beverage product from the inner volume, the fluid inlet and the dispensing outlet being positioned at the bottom of the pack and being at least partially positioned between two joined edges of the sheets of material, the fluid inlet being oriented essentially perpendicularly to the plane defined by the inner volume, the dispensing outlet being configured as an essentially parallel tube arranged essentially vertically from the inner volume, configured so as to enable a free flow of the food or beverage product form the pack, the dispensing outlet comprising a primary outlet section and a secondary outlet section, the secondary outlet section being arranged vertically higher than the primary outlet section and having a greater diameter than that of the primary outlet section, the configuration allowing the sequential dispensing of the food or beverage product at least in two phases, a first phase where dispensing is done through the primary outlet section and a second phase where dispensing is done through the secondary outlet section, the machine comprising: a receiving area adapted to accommodate the pack in an essentially vertical position during beverage production with the fluid inlet and the dispensing outlet being arranged at the bottom of the pack, the machine further comprising an injector designed for accommodating fluid into the fluid inlet.

17. Machine according to claim 16 further comprising a data reader retrieving the parameters information for the fluid supply into the fluid inlet, comprising the information on the sequential dispensing phases and their duration in time and, for each phase the information of at least one or a combination of: temperature of the fluid introduced in the inlet chamber; total volume of fluid introduced in the inlet chamber; fluid flow provided into the inlet chamber; and/or duration of jet phase and pause in between jet phases.
